(19) United States
(12) Patent Application Publication
(10) Pub. No.: US 2011/0154285 A1
(43) Pub. Date: Jun. 23, 2011

(54) INTEGRATED MANAGEMENT APPARATUS AND METHOD FOR EMBEDDED SOFTWARE DEVELOPMENT TOOLS

(75) Inventor: Jeong Si KIM, Daejeon (KR)

(73) Assignee: Electronics and Telecommunications Research Institute, Daejeon (KR)

(21) Appl. No.: 12/848,584

(22) Filed: Aug. 2, 2010

(30) Foreign Application Priority Data
Dec. 21, 2009 (KR) 10-2009-0128058

(51) Int. Cl. G06F 9/44

(52) U.S. Cl. 717/101

(57) ABSTRACT

Provided is an integrated management apparatus and method for embedded software development tools, which can support all the development tools used in the process of developing embedded software under a single environment, and provide a developer with a development environment optimized to development work through the support of an integrated project and an integrated tool user interface (UI) on the basis of a development environment type. Thus, it is possible to increase efficiency of the embedded software development work.

### CROSS-REFERENCE TO RELATED APPLICATION

This application claims priority to and the benefit of Korean Patent Application No. 10-2009-0128058, filed Dec. 21, 2009, the disclosure of which is incorporated herein by reference in its entirety.

### BACKGROUND

1. Field of the Invention

The present invention relates to an integrated management apparatus and method for embedded software development tools and, more particularly, to an integrated management technique for development tools, capable of supporting a development environment optimized to development work of a developer.

2. Discussion of Related Art

Embedded systems are electronic control systems in which hardware and software are combined to perform a specific function.

Typical embedded systems include those found in household electric appliances such as digital video disc (DVD) players, set-top boxes, MP3 players, camcorders, digital cameras, refrigerators, and washing machines Elevators, medical instruments, automobiles, factory controllers, communication equipment (exchangers, routers, etc.), etc. also have corresponding embedded systems.

Such an embedded system is not configured of merely a circuit, but has built-in software that performs a specific function through a microprocessor. For example, conventional washing machines are simple appliances featuring only washing and spin-drying, while washing machines entering the market nowadays are capable of washing in consideration of a type of fabric, a volume of clothes to be washed, a temperature of water, and so on. In this manner, a task that is hard to perform with the conventional system can be easily performed using the embedded system in which the microprocessor and its related software are installed.

Meanwhile, embedded software installed in an embedded system must be developed in consideration of a target system. To this end, many development tools supporting development work of the embedded software are being developed and applied.

However, most development tools applied at present are realized to support only a specific function, and it is inconvenient for a developer to find the development tool suitable for each development function for proper application. Further, the development tools have different commands and interface systems, and it is not easy for the developer to use various development tools.

### SUMMARY OF THE INVENTION

The present invention is directed to supporting all development tools required to develop embedded software in a single environment based on a graphical user interface (GUI).

The present invention is also directed to integrating projects and user interfaces (UIs) of each development tool required for development work to provide a developer with a development environment optimized to development work.

An aspect of the present invention is to provide an integrated management apparatus for embedded software development tools, which includes: an integrated project manager generating an integrated project constituted of projects of development tools included in a development environment type and providing a UI for the integrated project; an integrated tool UI manager defining and managing the development environment type and providing and managing a development environment UI constituted of UIs of the development tools included in the development environment type; and an integrated management setter registering and managing the projects and the UIs of the respective development tools with the integrated project and the integrated UI on the basis of the development environment type.

The integrated project manager, the integrated tool UI manager, and the integrated management setter may be realized using an integrated management application executable in a computer. Here, the integrated management application may support all the development tools required for development work under a single use environment based on a GUI.

Another aspect of the present invention is to provide an integrated management method for embedded software development tools, which includes: integrating projects and UIs of respective development tools to set an integrated project and an integrated tool UI; defining a development environment type for development work; and when a specific development environment type is selected by a developer, generating and displaying the integrated project based on the selected development environment type on a screen, and displaying a development environment UI based on the selected development environment type on the screen.

The integrated management method may further include, after generating and displaying the integrated project: when a development tool conversion command is input by the developer, checking whether or not the development tool is included in a present development environment type; and when the development tool is included in the present development environment type, converting the development tool without changing the development environment UI, and when the development tool is included in another development environment type, displaying a development environment UI based on the other development environment type on the screen.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a block diagram illustrating an integrated management apparatus for embedded software development tools according to an exemplary embodiment of the present invention;

FIGS. 2A through 2D illustrate an example of the integrated management apparatus for embedded software development tools of FIG. 1 realized using an integrated management application executable in a computer; and

FIG. 3 is a flowchart illustrating an integrated management method for embedded software development tools according to an exemplary embodiment of the present invention.

### DETAILED DESCRIPTION OF EXEMPLARY EMBODIMENTS

The present invention will be described more fully hereinafter with reference to the accompanying drawings, in which exemplary embodiments of the invention are shown. This invention may, however, be embodied in different forms and should not be construed as limited to the embodiments set forth herein. In the following description of the present invention, a detailed description of known functions and components incorporated herein will be omitted or simplified when it may make the subject matter of the present invention rather unclear. It should be noted that the same reference numbers are used in the figures to denote the same elements.

A characteristic of the present invention is to define embedded software development tools required for development work among various embedded software development tools as a development environment type, and integrate and provide projects and user interfaces (UIs) of the respective development tools on the basis of the defined development environment type, thereby making it possible to provide a development environment optimized to the development work. This characteristic will be more clearly understood through the following exemplary embodiment.

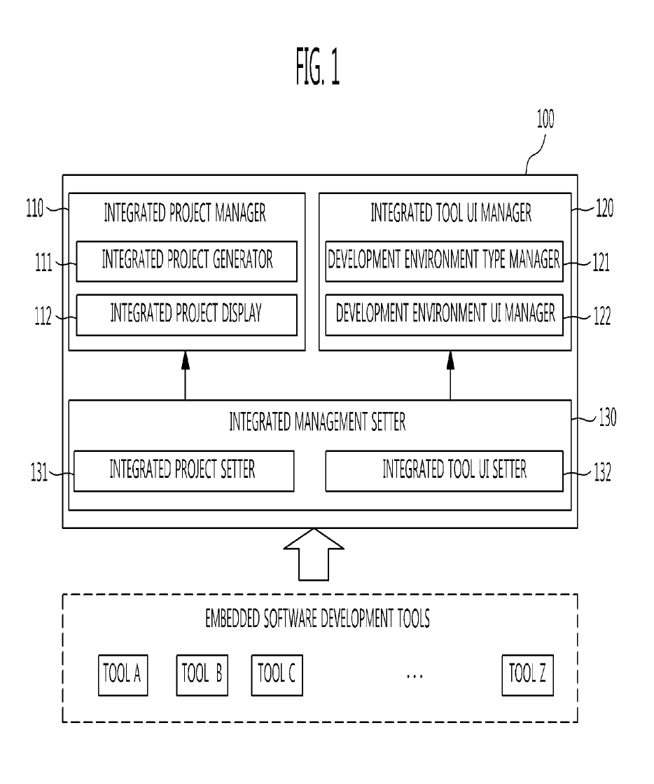

FIG. 1 is a block diagram illustrating an integrated management apparatus 100 for embedded software development tools according to an exemplary embodiment of the present invention.

Referring to FIG. 1, the integrated management apparatus 100 for embedded software development tools according to an exemplary embodiment of the present invention includes an integrated project manager 110 generating an integrated project constituted of projects of development tools included in a development environment type and providing a UI for the integrated project, an integrated tool UI manager 120 defining and managing the development environment type and providing and managing a development environment UI constituted of UIs of the development tools included in the development environment type, and an integrated management setter 130 registering and managing the projects and the UIs of the development tools with the integrated project and the integrated UI on the basis of the development environment type.

The integrated project manager 110 includes an integrated project generator 111 generating the integrated project constituted of the projects of the development tools included in the development environment type among development tools, and an integrated project display 112 structurally displaying content of the generated integrated project and providing the UI for project commands.

The integrated tool UI manager 120 includes a development environment type manager 121 defining and managing the development environment type for a target system, and a development environment UI manager 122 providing and managing the development environment UI constituted of the UIs of the development tools included in the development environment type.

The integrated management setter 130 includes an integrated project setter 131 registering and managing the projects of the development tools with the integrated project, and an integrated tool UI setter 132 registering and managing the UIs of the development tools with the integrated UI. In detail, the integrated project setter 131 processes setting of registration of a development tool that can be included in the integrated project in a specific development environment type, and the integrated tool UI setter 132 processes setting of registration of a development tool that can be included in the integrated tool UI in the specific development environment type.

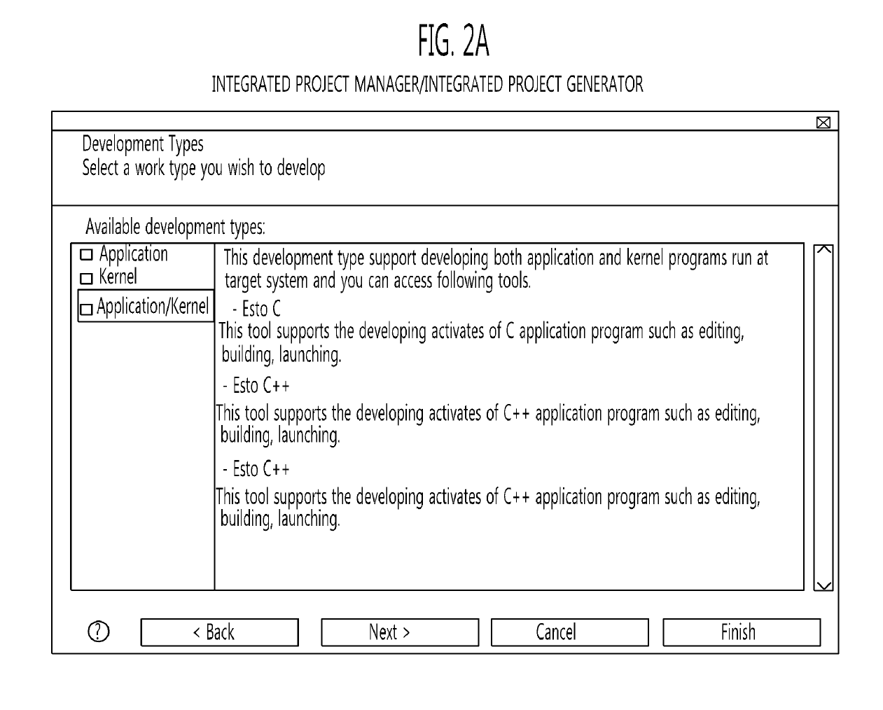

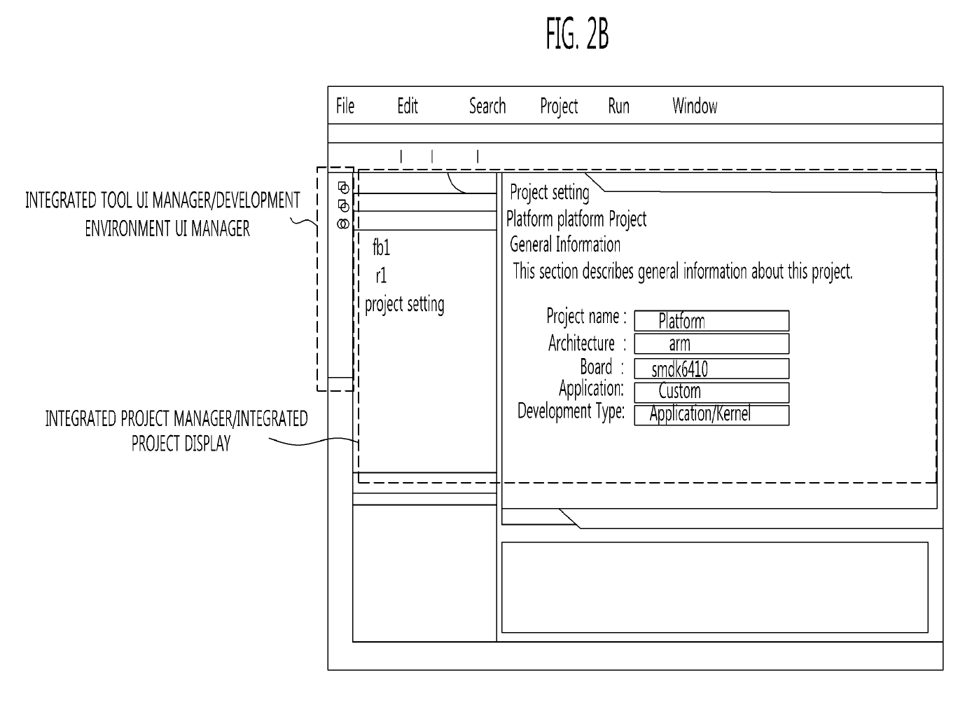

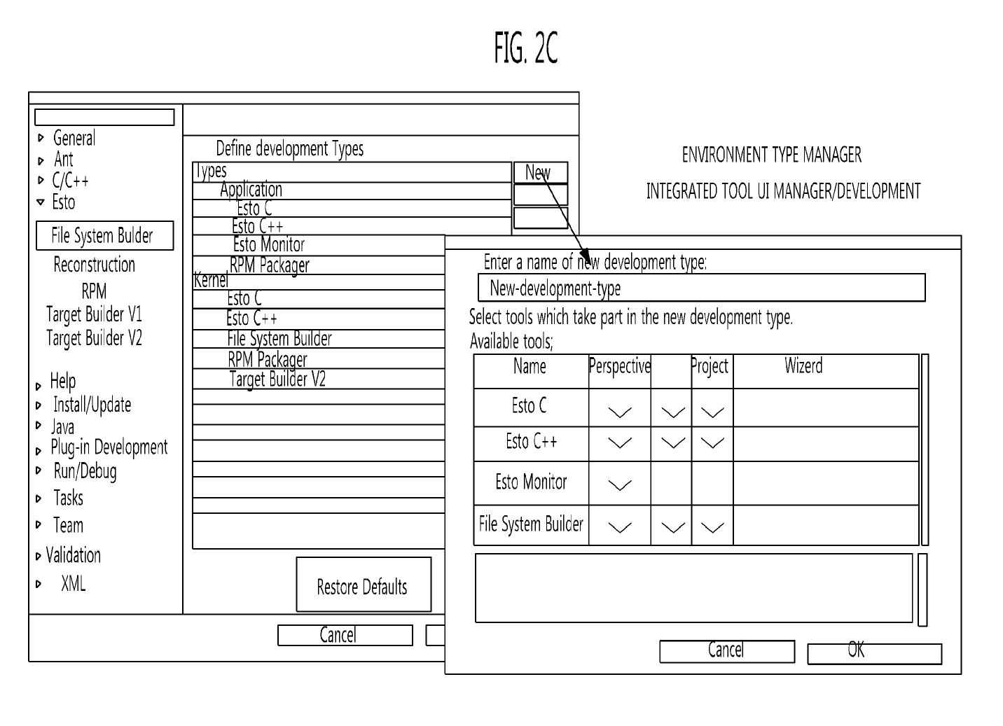

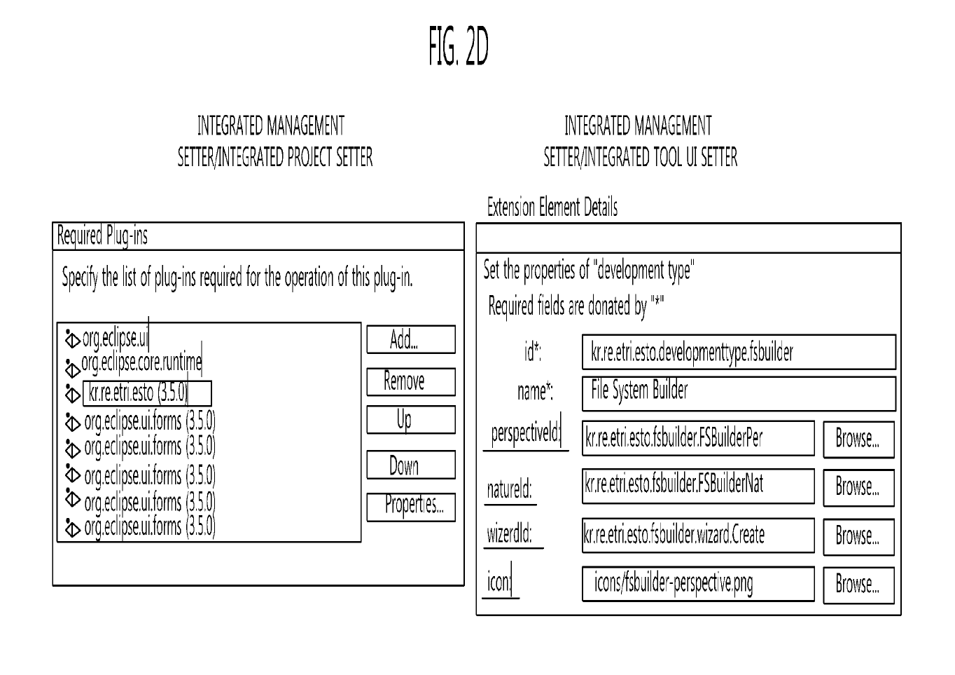

The integrated management apparatus 100 for embedded software development tools configured in this way can be realized using an integrated management application executable in a computer. This will be described below in detail with reference to FIGS. 2A through 2D.

FIGS. 2A through 2D illustrate an example of the integrated management apparatus 100 for embedded software development tools of FIG. 1 realized using an integrated management application executable in a computer.

Referring to FIG. 2A, the integrated project generator 111 of the integrated project manager 110 generates the integrated project on the basis of the development environment type selected by a developer.

Referring to FIG. 2B, the integrated project display 112 of the integrated project manager 110 supports the generated integrated project so that the integrated project can be managed in a single view, and supports the project commands associated with the corresponding project to so that the project commands can be executed through the UI.

The development environment UI manager 122 of the integrated tool UI manager 120 provides the development environment UI optimized to the corresponding development work on the basis of the development environment type selected by the developer.

Referring to FIG. 2C, the development environment type manager 121 of the integrated tool UI manager 120 supports a developer to define a development environment type. The defined development environment type is provided to the developer in the process of generating an integrated project as illustrated in FIG. 2A.

Referring to FIG. 2D, the integrated project setter 131 and the integrated tool UI setter 132 of the integrated management setter 130 support a setup of the integrated project and a setup of the integrated UI.

In this way, the integrated management apparatus 100 for embedded software development tools according to an exemplary embodiment of the present invention is configured to support all development tools required for development work of a developer under a single use environment based on a graphical user interface (GUI).

In particular, the integrated management apparatus 100 for embedded software development tools defines development tools required for development work as a development environment type, and integrates and provides projects and UIs of respective development tools on the basis of the development environment type, so that a developer can be provided with the development environment optimized to the development work. Thus, it is possible to increase efficiency of the embedded software development work.

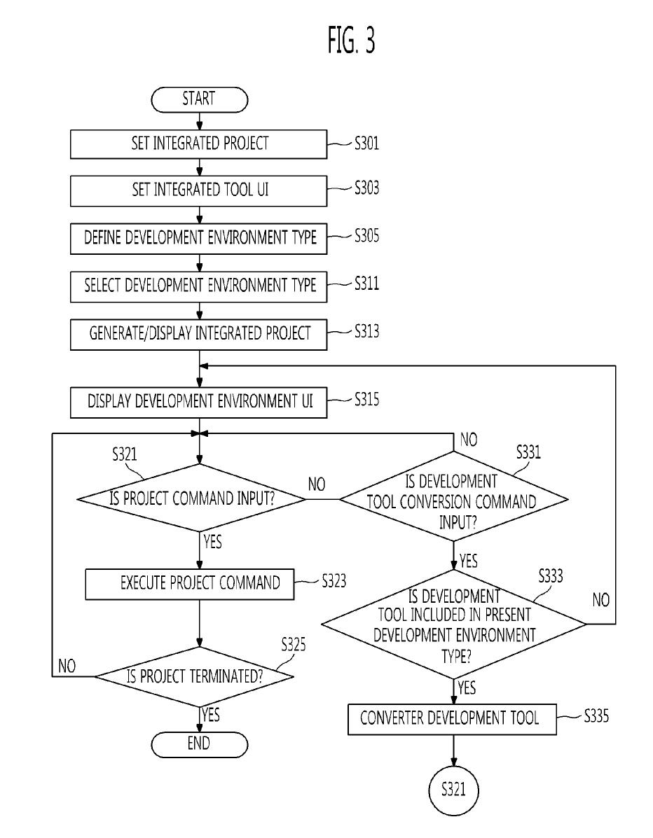

FIG. 3 is a flowchart illustrating an integrated management method for embedded software development tools according to an exemplary embodiment of the present invention. In FIG. 3, the development tools are integrated and managed using the integrated management application executable in the computer.

First, an integrated project constituted of projects of respective development tools is set (S301), and an integrated tool UI constituted of UIs of the respective development tools is set (S303).

Then, a development environment type for a target system is defined (S305)

When a specific development environment type suitable for development work is selected by a developer (S311), an integrated project based on the selected development environment type is generated and displayed on a screen (S313), and a development environment UI based on the selected development environment type is displayed on the screen (S315).

When a project command is input by the developer (S321), the project command is executed (S323). When a project termination command is input, the development work is terminated (S325).

When a development tool conversion command is input by the developer (S331), it is checked whether or not the development tool is included in a present development environment type (S333). When the development tool is included in the present development environment type, the development tool is converted without changing the development environment UI (S335). On the other hand, when the development tool is included in another development environment type, a development environment UI based on the other development environment type is displayed on the screen (S315).

As described above, an integrated management apparatus and method for embedded software development tools set development tools required for a development work among various development tools as a development environment type, and integrate and provide projects and UIs of the respective development tools on the basis of the defined development environment type, thereby making it possible to provide a developer with a development environment optimized to the corresponding development work.

An integrated management apparatus and method for embedded software development tools according to exemplary embodiments of the present invention can support all the development tools used in the process of developing embedded software under a single environment based on a GUI, and provide a developer with a development environment optimized to development work through the support of an integrated project and an integrated UI based on a development environment type. Thus, it is possible to increase efficiency of the embedded software development work.

The exemplary embodiments of the present invention described above can be recorded as a program executable in a computer, and be realized in a general-purpose digital computer executing the program using a computer-readable recording medium.

While the invention has been described with reference to certain exemplary embodiments thereof, it will be understood by those skilled in the art that various changes in form and details may be made therein without departing from the spirit and scope of the invention as defined by the appended claims.

What is claimed is:

1. An integrated management apparatus for embedded software development tools, comprising:
an integrated project manager generating an integrated project constituted of projects of development tools included in a development environment type and providing a user interface (UI) for the integrated project;
an integrated tool UI manager defining and managing the development environment type and providing and managing a development environment UI constituted of UIs of the development tools included in the development environment type; and
an integrated management setter registering and managing the projects and the UIs of the respective development tools with the integrated project and the integrated UI on the basis of the development environment type.

2. The integrated management apparatus according to claim 1, wherein the integrated project manager includes:
an integrated project generator generating the integrated project constituted of the projects of the development tools included in the development environment type among development tools; and
an integrated project display structurally displaying content of the generated integrated project and providing the UI for project commands.

3. The integrated management apparatus according to claim 1, wherein the integrated tool UI manager includes:
a development environment type manager defining and managing the development environment type for a target system; and
a development environment UI manager providing and managing the development environment UI constituted of the UIs of the development tools included in the development environment type.

4. The integrated management apparatus according to claim 1, wherein the integrated management setter includes:
an integrated project setter registering and managing the projects of the respective development tools with the integrated project; and
an integrated tool UI setter registering and managing the UIs of the respective development tools with the integrated UI.

5. The integrated management apparatus according to claim 1, wherein the integrated project manager, the integrated tool UI manager, and the integrated management setter are realized using an integrated management application executable in a computer.

6. The integrated management apparatus according to claim 5, wherein the integrated management application supports all the development tools required for development work under a single use environment based on a graphical user interface (GUI).

7. An integrated management method for embedded software development tools, comprising:
integrating projects and user interfaces (UIs) of respective development tools to set an integrated project and an integrated tool UI;
defining a development environment type for development work; and
when a specific development environment type is selected by a developer, generating and displaying the integrated project based on the selected development environment type on a screen, and displaying a development environment UI based on the selected development environment type on the screen.

8. The integrated management method according to claim 7, further comprising, after generating and displaying the integrated project, when a project command is input by the developer, executing the project command.

9. The integrated management method according to claim 7, further comprising, after generating and displaying the integrated project:
when a development tool conversion command is input by the developer, checking whether or not the development tool is included in a present development environment type; and
when the development tool is included in the present development environment type, converting the development tool without changing the development environment UI, and when the development tool is included in another development environment type, displaying a development environment UI based on the other development environment type on the screen.
